(19) United States
(12) Patent Application Publication
(10) Pub. No.: US 2023/0264655 A1
(43) Pub. Date: Aug. 24, 2023

(54) Rechargeable Key Fob

(71) Applicants: Leigh Ann Reber, Sacramento, CA (US); Carl Ray Jackson, Sacramento, CA (US)

(72) Inventors: Leigh Ann Reber, Sacramento, CA (US); Carl Ray Jackson, Sacramento, CA (US)

(21) Appl. No.: 17/586,148

(22) Filed: Jan. 27, 2022

(51) Int. Cl. B60R 25/40; B60L 1/02; H02J 50/90; H02J 7/00; B60R 25/24

(52) U.S. Cl. CPC B60R 25/406; B60L 1/02; B60R 25/24; H02J 7/0044; H02J 50/90; B60L 2250/16; H02J 2207/30

(57) ABSTRACT

The key fob charger is the only product of its kind that enables users to conveniently recharge their vehicle’s key fob through a magnetic USB connection, a wireless charging pad, and even an average home adapter. This unprecedented product is uniquely designed with cutting-edge, highly advanced technologies and durable materials to ensure long term sustainability, in addition, the key fob charger can be installed into all vehicles with a push start ignition to enhance and improve overall driver experience.

### BACKGROUND

Push button start features are now the most commonly used ignition in modern automobiles. The likelihood of the push start button effectiveness, however, is highly dependent upon the battery power source used in the fob. If a key fob has a low or dead battery, the system likely won’t be able to recognize when the fob is either near or inside the car, and accordingly, won’t start the engine. Moreover, when the key fob battery dies, individuals might be able to use the hidden key within the fob to start their car; yet, newer car models are moving away from this back-up option which means if a person does not have access to swap the dead battery with a new one, their only recourse is to remain stranded as they await a tow and/or professional aide. There have been no products available as original equipment or as an aftermarket to address this problem.

An apparatus to aid key fob batteries from dying and prevent drivers from not being able to use their vehicle due to a dead battery is not being met by any known device or system at present. There have been no products available as original equipment or as an aftermarket to address this problem either.

### SUMMARY OF THE INVENTION

The main purpose of the rechargeable key fob device is to provide users with a rechargeable key fob system for vehicles.

### BRIEF DESCRIPTION OF THE DRAWINGS

FIG. 1 is a top perspective view of the rechargeable key fob device in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

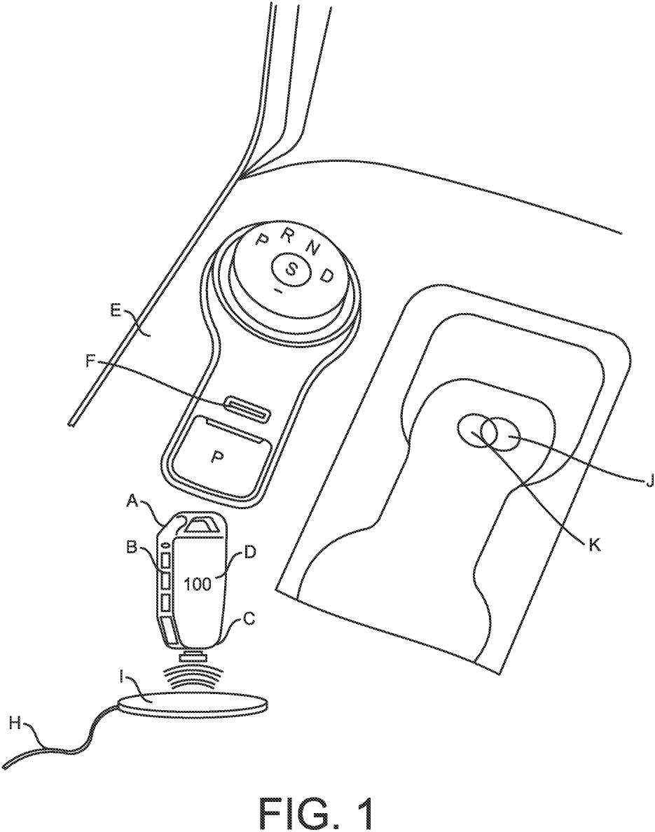

FIG. 1 is a top perspective view of the rechargeable key fob device showing: keyless entry remote referenced as A, sends alert to phone & car when charge is below 25% referenced as B, magnetic USB charging connection referenced as C, charge indicator referenced as D, center console referenced as E, magnetic/wireless charger referenced as F, home adapter or battery pack referenced as G, power cord referenced as H, wireless charging pad comes in different decorative designs referenced as I in accordance with an embodiment of the present disclosure. A positional magnet J and a battery charging circuit K are located in a cup holder or a recess of the vehicle console.

The present disclosed rechargeable key fob device also known as the “Key Fob Charger” offers a modem fob adaption that helps eliminate the need for individuals to constantly purchase new batteries for their auto key fob by providing them with a rechargeable vehicle key fob to ensure complete functionality, at all times. Expanding on the initial design of the center console in vehicles, the key fob charger introduces a novel keyless entry remote system with a magnetic USB key fob charging connection and a wireless charging pad. With advanced technology, when a low battery is detected on the key fob, the system sends an alert to both the user’s cellular device and the vehicle itself, notifying users to charge their fobs. They can then select from varying options the best method for charging the device by either: placing the key fob onto the wireless charging pad, plugging the key fob into the magnetic USB charging connection, or to charge it through a regular home adapter or battery pack. With the help of the key fob charger, consumers will never have to deal with the inconvenience of a dead key fob charger that would otherwise prevent them from starting their cars as the ability to conveniently charge their fobs at any time, and in any location, serves to guarantee their automobiles are fully accessible.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A vehicle keyless entry system comprising:
a fob powered by a battery and comprising a keyless entry remote circuit powered by the battery and comprising a recharge circuit for the battery and a positional magnet;
a charging circuit for the battery configured proximal a console of the vehicle; and
a positional magnet proximal the console of the vehicle configured to align the fob charging circuit with the console charging circuit via a match of the positional magnets in the fob and in the console.

2. The system of claim 1, wherein the charging circuit for the battery proximal the console is in a cup holder of the console.

3. The system of claim 1, wherein the charging circuit for the battery proximal the console is in a recess of the console.

4. The system of claim 1, wherein the charging circuit for the battery proximal the console is in a remote charging pad proximal the console.

5. The system of claim 1, wherein the positional magnet proximal the console is in a cup holder of the console.

6. The system of claim 1, wherein the positional magnet proximal the console is in a recess of the console.

7. The system of claim 1, wherein the positional magnet proximal the console is in a remote charging pad proximal the console.

8. The system of claim 1, further comprising a charge indicator circuit and display of a status thereof in the fob.

9. The system of claim 1, further comprising a charge indicator circuit and a display of a status thereof in the console.

10. The system of claim 1, further comprising a charge indicator circuit and a display of a status thereof in a remote charging pad proximal the console.

11. The system of claim 1, further comprising a USB (universal serial bus) connection in the fob to an ancillary remote power and charging source.

12. The system of claim 1, further comprising a power connection from a vehicle power source to the console charging circuit.
